(19) United States
(12) Patent Application Publication
(10) Pub. No.: US 2025/0164005 A1
(43) Pub. Date: May 22, 2025

(54) VEHICLE DRIVE SYSTEM

(71) Applicant: Hitachi Astemo, Ltd., Hitachinaka-shi, Ibaraki (JP)

(72) Inventors: Kenta SUZUKI, Tokyo (JP); Takaki ITAYA, Hitachinaka-shi, Ibaraki (JP); Kosaku ONO, Tokyo (JP)

(73) Assignee: Hitachi Astemo, Ltd., Hitachinaka-shi, Ibaraki (JP)

(21) Appl. No.: 18/841,313

(22) PCT Filed: Sep. 8, 2022
(86) PCT No.: PCT/JP2022/033796

§ 371 Date: Aug. 23, 2024

(30) Foreign Application Priority Data
Mar. 2, 2022 (JP) 2022-031577

(51) Int. Cl. F16H 57/04; H02K 7/00; H02K 7/116; H02K 9/19

(52) U.S. Cl. CPC F16H 57/0476; F16H 57/045; H02K 7/006; H02K 7/116; H02K 9/19

(57) ABSTRACT

Provided is a vehicle drive system that reduces oil agitation loss which occurs in a reduction gear during vehicle startup, and that sufficiently sends a cooling oil to a motor to improve the reliability of the motor. This vehicle drive system 100a is characterized by comprising: an electric motor 1; a reduction gear 2; a reduction gear casing 2b that houses the reduction gear 2; an oil 8 that is accommodated in the reduction gear casing 2b; an oil storage unit vertically over the electric motor 1; a pump 3 that sends the oil 8 stored in a lower portion of the reduction gear 2 to the oil storage unit 5; a pipe 9 that connects the oil storage unit 5 and the electric motor 1; a valve 6 that is provided to the pipe 9 to control conduction/interruption of the pipe 9; and a control device 20 that controls the electric motor 1, the reduction gear 2, the pump 3, and the valve 6. This vehicle drive system is also characterized in that the control device 20 uses the valve 6 to control the starting/stopping of supply of the oil 8 from the oil storage unit 5 to the electric motor 1.

### TECHNICAL FIELD

The present invention relates to a vehicle drive system.

### BACKGROUND ART

A traction unit that generates a driving force of an electric vehicle (EV) achieves light weight, high power, and space saving by integrating three of an electric motor, an inverter, and a speed reducer. In such an electric motor (hereinafter, also simply referred to as a “motor”) that achieves both high power and miniaturization, a stator coil, a bearing, and the like constituting the motor have a high temperature when being rotated at a high speed, and thus it is necessary to cool them. Therefore, there is known a configuration in which oil accumulated in a lower portion of a casing of the speed reducer for lubrication of the speed reducer is fed to a motor side by scraping up or the like along with rotation of an electric pump or a speed reducer gear, and the oil is applied to a coil of the motor to cool the coil, that is, a configuration in which lubricating oil of the speed reducer also serves as cooling oil of the motor.

Examples of the drive system having the above-described configuration include PTL 1 and PTL 2. The drive device 5 of PTL 1 has a configuration in which a rotary electric machine MG2, a speed reduction mechanism 40, and a differential device 45 are accommodated in a housing chamber 72 of a housing 70. Above the rotary electric machine MG2, an upper storage chamber 74 that stores lubricating oil to be supplied to the rotary electric machine MG2 is provided, and a flow rate adjusting means (electric pump 80) for adjusting a flow rate of the lubricating oil pumped up from the housing chamber 72 to the upper storage chamber 74 is provided. The control device 60 controls the electric pump 80 such that the oil level position of the lubricating oil in the housing chamber changes according to the operating state of the drive device 5.

PTL 1 describes that the control device 60 controls the electric pump 80 according to the operating state of the drive device 5 such as the rotational speeds of the rotor 32 of the rotary electric machine and the gear of the power transmission mechanism, or the oil temperature of the lubricating oil in the housing chamber 72, and changes the oil level position of the lubricating oil in the housing chamber 72 to an optimum oil level position. With such a configuration, the oil level position of the lubricating oil can be controlled to an optimum oil level position according to the operating state, and the friction stir resistance received by the rotor and the gear can be reduced while ensuring good lubrication portion requiring lubrication.

Further, the drive system 1 of PTL 2 includes a storage tank 21 in which the rotary electric machine 5, the speed reducer 4, and the gear 44 are accommodated in the housing 2, and at least one of the gears 44 is immersed in the lubricating oil, and an oil catch tank 20 that is provided above the rotary electric machine 5 and temporarily stores the lubricating oil scraped up by the gear 44 of the speed reducer 4. There is described a configuration including a first discharge port 31 through which the lubricating oil flows down from the oil catch tank 20 to the rotary electric machine 5, a second discharge port 3 that is provided below the first discharge port 31 and through which the lubricating oil flows down from the oil catch tank 20 to the rotary electric machine 5, and a valve 33 that opens and closes the second discharge port 3 in accordance with the operating state of the drive system 1, in which the amount of oil stored in the oil catch tank 20 changes in accordance with the open/close state of the valve 33. The open/close state of the valve 33 is changed depending on the operation state.

According to PTL 2, since the second discharge port 3 is opened and closed according to the operating state, the amount of oil stored in the oil catch tank 20 increases when the second discharge port is closed, and the oil level of the storage tank in which the gear of the speed reducer is immersed decreases, so that the resistance to scraping is reduced, and the loss of the drive system can be reduced. For example, in a case where the oil temperature of the lubricating oil is low and the viscosity is low, such as in an operation state before the completion of warming up of the drive system 1 such as at the time of cold start of the drive system 1, the second discharge port 3 is closed, and a large amount of lubricating oil is stored in the oil catch tank 20, so that it is possible to reduce the loss of energy due to the increase in the resistance to scraping by the gear by lowering the oil level.

### CITATION LIST

### Patent Literature

PTL 1: JP 2007-247706 A

PTL 2: JP 2020-198675 A

### SUMMARY OF INVENTION

### Technical Problem

However, in the vehicle drive systems of PTL 1 and PTL 2 described above, the position of the oil level of the speed reducer during traveling of the vehicle and the amount of oil flowing to the rotary electric machine are adjusted, but the loss of the stirring resistance of the speed reducer when starting from the stop state of the vehicle is not considered. When the entire oil is accumulated in the lower portion of the speed reducer at the time of stopping the vehicle, the stirring resistance becomes the largest at the time of starting the vehicle. In particular, in winter or cold climates, when the temperature of the environment in which the vehicle is placed is 0° C. or lower, it is difficult to suck up the oil with the pump or to scrape up the oil to the upper portion of the motor with the gear of the speed reducer. When a high load is applied to the motor at a low temperature, the coil of the motor has a high temperature. However, when the viscosity of the oil is high at a low temperature, it is difficult to flow the oil to the coil of the motor having a high temperature, which may affect the reliability of the motor.

Therefore, an object of the present invention is to provide a vehicle drive system capable of reducing an oil stirring loss of a speed reducer at the time of starting a vehicle, sufficiently flowing cooling oil to a motor, and improving reliability of the motor.

### Solution to Problem

One aspect of the present invention for achieving the above object is a vehicle drive system including: an electric motor configured to be rotationally driven; a speed reducer configured to reduce a rotational speed of the electric motor; a speed reducer casing configured to house the speed reducer; an oil accommodated in the speed reducer casing; an oil reservoir provided vertically above the electric motor; a pump configured to send the oil stored in a lower portion of the speed reducer to the oil reservoir; a pipe configured to connect the oil reservoir and the electric motor; a valve provided in the pipe to control conduction/interruption of the pipe; and a control device configured to control the electric motor, the speed reducer, the pump, and the valve, in which the control device controls start and stop of supply of oil from the oil reservoir to the electric motor by the valve.

### Advantageous Effects of Invention

According to the vehicle drive system of the present invention, therefore, the present invention can reduce the stirring loss of the oil of a speed reducer at the time of starting a vehicle, sufficiently flow the cooling oil to a motor, and improve the reliability of the motor.

### BRIEF DESCRIPTION OF DRAWINGS

FIG. 1 is an axial cross-sectional view illustrating a first example of a vehicle drive system of the present invention.

FIG. 2 is an axial cross-sectional view illustrating a second example of the vehicle drive system of the present invention.

FIG. 3 is a flowchart illustrating a first example of the operation of the vehicle drive system of the present invention.

FIG. 4 is an axial cross-sectional view illustrating a third example of the vehicle drive system of the present invention.

FIG. 5 is an axial cross-sectional view illustrating a fourth example of the vehicle drive system of the present invention.

FIG. 6 is a radial cross-sectional view illustrating a fifth example of the vehicle drive system of the present invention.

FIG. 7 is a radial cross-sectional view illustrating a sixth example of the vehicle drive system of the present invention.

FIG. 8 is a radial cross-sectional view illustrating a seventh example of the vehicle drive system of the present invention.

FIG. 9 is a radial cross-sectional view illustrating an eighth example of the vehicle drive system of the present invention.

FIG. 10 is a radial cross-sectional view illustrating a ninth example of the vehicle drive system of the present invention.

FIG. 11 is a flowchart illustrating a second example of the operation of the vehicle drive system of the present invention.

FIG. 12 is a flowchart illustrating a third example of the operation of the vehicle drive system of the present invention.

### DESCRIPTION OF EMBODIMENTS

Hereinafter, an embodiment of a vehicle drive device according to the present invention will be described with reference to the drawings.

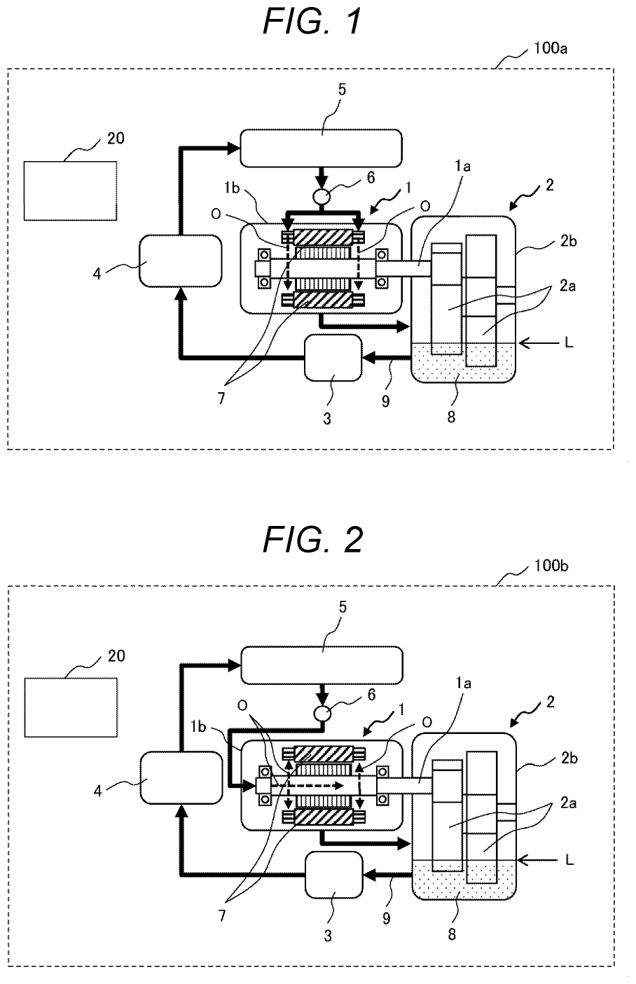

First, a structure of each exemplary embodiment will be described with reference to FIGS. 1 and 2 which are schematic configuration diagrams schematically illustrating the embodiment, and then a characteristic configuration of each embodiment will be specifically described for each embodiment.

FIG. 1 is an axial cross-sectional view (motor rotary shaft) illustrating a first example of a vehicle drive system of the present invention. As illustrated in FIG. 1, a vehicle drive system 100a includes an electric motor 1 having a motor rotary shaft 1a that is rotationally driven, and a speed reducer 2 having a gear 2a for reducing the rotational speed of the motor rotary shaft 1a. By connecting the speed reducer 2 to the electric motor 1 that rotates at a high speed, the rotational torque is increased to drive the vehicle. The electric motor 1 is accommodated in an electric motor casing 1b, and the gear 2a is accommodated in a speed reducer casing 2b. An oil 8 for lubricating the gear 2a is accommodated in the speed reducer casing 2b.

An oil reservoir 5 is provided vertically above the electric motor 1. The speed reducer casing 2b, the oil reservoir 5, and the electric motor casing 1b are connected by a pipe 9. An arrow of the pipe 9 indicates a direction in which the oil 8 flows. The oil 8 stored in the lower portion of the speed reducer casing 2b is carried to the electric motor 1 through the pipe 9, and for example, the oil (O) flows in the direction of the broken line arrow in the drawing to cool the components (for example, a stator coil 7) of the electric motor 1. The pipe 9 is provided with a pump 3 for sending the oil 8 and an oil cooler 4 for cooling the oil 8.

The pipe 9 connecting the oil reservoir 5 and the electric motor casing 1b is provided with a valve 6 for controlling conduction/interruption of the pipe 9.

The vehicle drive system 100a includes a control device 20 that controls the electric motor 1, the speed reducer 2, the pump 3, and the valve 6, and controls start and stop of supply of the oil 8 from the oil reservoir 5 to the electric motor 1 by the valve 6. When the valve 6 is in conduction (valve “open” state), the oil 8 cools the stator coil 7 from the upper portion of the motor 1 and returns to the speed reducer 2. On the other hand, when the valve 6 is shut off (valve “closed” state), the oil 8 does not flow to the motor 1, and the oil 8 is accumulated in the oil reservoir 5.

For example, the control device 20 opens the valve 6 and operates the pump 3 at the time when the temperature of the electric motor 1 rises above a preset value after the vehicle is started.

FIG. 2 is an axial cross-sectional view illustrating a second example of the vehicle drive system of the present invention. The basic configuration of a vehicle drive system 100b illustrated in FIG. 2 is the same as that of FIG. 1, but is a structure in which the oil 8 having passed through the valve 6 is blown from the inside of the electric motor 1 to the stator coil 7 through the motor rotary shaft 1a to be cooled. As illustrated in FIG. 1, there are generally known two systems of cooling of the electric motor 1, that is, a system of flowing oil from the upper portion of the electric motor 1 to the stator coil 7, and a system of blowing oil from the inside of the motor rotary shaft 1a to the stator coil 7 as illustrated in FIG. 2. Furthermore, when the two systems are combined, a larger cooling effect can be expected.

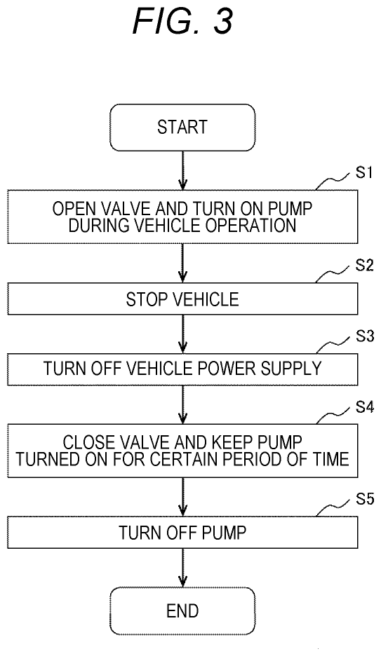

FIG. 3 is a flowchart illustrating an example of an operation of the vehicle drive system of the present invention. FIG. 3 illustrates control of the valve 6 in the operation from driving to stopping of the vehicle. As illustrated in FIG. 3, in the operation flow of the vehicle drive system of the present invention, the valve 6 is opened and the pump 3 is turned on during vehicle operation, and the oil 8 is supplied from the speed reducer casing 2b to the electric motor casing 1b through the oil reservoir 5 (S1). Next, the vehicle is stopped (S2), the vehicle power supply is turned off (S3), the valve 6 is closed, and the pump 3 is driven for a predetermined time (S4). With such an operation, the oil 8 is continuously fed from the speed reducer casing 2b to the oil reservoir 5, so that the oil level (L in FIGS. 1 and 2) of the speed reducer casing 2b is lowered. On the other hand, since the valve 6 is closed, the oil 8 is accumulated in the oil reservoir 5. Finally, the pump 3 is turned off (S5), and the delivery of the oil 8 is stopped.

Since the vehicle drive system of the present invention has the above-described configuration, the oil level L of the speed reducer 2 is lowered at the time of starting the vehicle, and the stirring loss of the speed reducer 2 at the time of starting the vehicle can be reduced. In particular, even in a case where the viscosity of the oil 8 is increased at a low temperature (for example, 0° C.) in an environment where the vehicle is placed, such as winter or a cold district, the stirring loss of the speed reducer 2 at the time of starting the vehicle can be reduced to the maximum.

In addition, since the oil reservoir 5 is filled with the oil at the time of starting the vehicle, the oil 8 can be supplied to the electric motor 1 to cool the electric motor 1 immediately after starting the vehicle. Even in a situation where the viscosity of the oil 8 increases and it takes time to supply the oil 8 to the electric motor 1 due to scraping of the speed reducer 2 when the environment in which the vehicle is placed is low temperature (for example, 0° C.), the oil 8 can be immediately supplied from the oil reservoir 5 to the electric motor 1, so that the reliability of the electric motor 1 can be secured.

In the present structure, it is also possible to control the oil level of the speed reducer 2 during operation by adjusting the opening of the valve 6 during operation. In this case, it is possible to reduce the stirring loss of the speed reducer 2 according to the operation state.

In PTL 1 described above, the oil level position of the lubricating oil in the housing chamber is controlled according to the operating state of the drive device during driving of the vehicle, and the lubricating oil is not fed to the upper storage chamber in the upper portion of the housing chamber after the vehicle is stopped, and the oil level position of the lubricating oil in the housing chamber is not lowered until the vehicle is started.

Also in PTL 2, the amount of lubricating oil flowing from the oil catch tank in the upper portion of the motor to the motor is adjusted by opening and closing the second discharge port according to the temperature during driving of the drive system. However, the lubricating oil is not fed to the oil catch tank after the vehicle is stopped, and the oil level position of the lubricating oil in the speed reducer is not lowered until the vehicle is started.

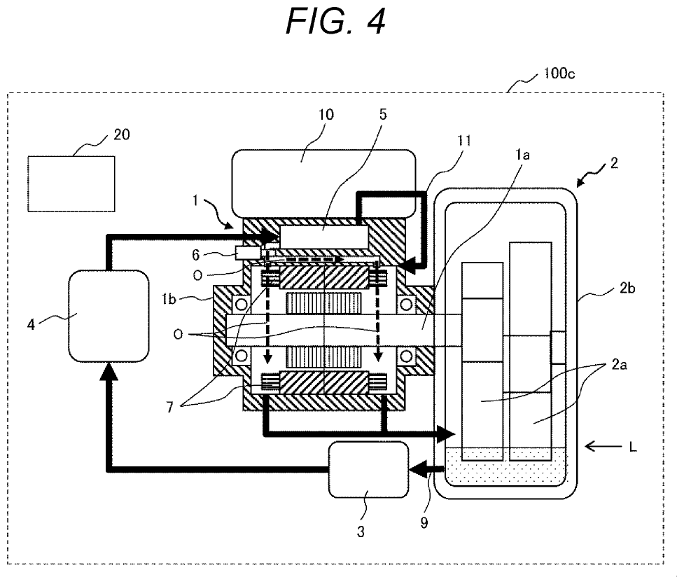

FIG. 4 is an axial cross-sectional view illustrating a third example of the vehicle drive system of the present invention. The basic structure is as described in FIGS. 1 and 2, but a drive system 100c in FIG. 4 has a breather 11 for venting air. Since it is difficult for the oil reservoir 5 to store oil when air enters, it is desirable to connect the breather 11 for removing air to the motor 1 or the speed reducer 2. When the valve 6 fails in the interruption state, it is difficult to cool the motor 1. Accordingly, the breather 11 is preferably connected to the motor 1.

In addition, in the vehicle drive system 100c illustrated in FIG. 4, the oil reservoir 5 is provided inside the electric motor casing 1b, and an inverter 10 is disposed in the upper portion of the motor 1. Since the oil reservoir 5 is provided inside the electric motor casing 1b, the oil reservoir 5 and the cooling unit of the motor 1 can be arranged closer to each other.

In a low temperature environment, the viscosity of the oil is high, and it is difficult to pump up the oil 8 of the speed reducer 2 with the pump 3 or scrape up the oil 8 with the gear 2a of the speed reducer 2. When the load of the motor 1 is high such as a slope at the time of starting the vehicle, the temperature of the stator coil 7 is expected to rapidly rise. However, at a low temperature at the time of starting the vehicle, it is difficult to send the oil early, and there is a possibility that the stator coil 7 cannot be cooled and reliability is lowered. Since the motor 1 and the inverter 10 generate heat during vehicle operation, when the oil reservoir 5 is installed at a position close to the motor 1 and the inverter 10, the oil stored in the oil reservoir 5 can be warmed early and the viscosity can be lowered, and the stator coil 7 can be cooled early.

FIG. 5 is an axial cross-sectional view illustrating a fourth example of the vehicle drive system of the present invention. Since the speed reducer 2 also generates heat during vehicle operation, it is desirable to actively cool a portion of the motor 1 close to the speed reducer 2. In the vehicle drive system 100c illustrated in FIG. 5, by installing the valve 6 at a position close to the speed reducer 2 of the motor 1, the flow path from the oil reservoir 5 to the stator coil 7 in a portion close to the speed reducer 2 is shortened, and a portion that is likely to have a high temperature can be actively cooled. In the axial cross-sectional view showing the fourth example of the vehicle drive system of the present invention, the breather 11 is connected to the speed reducer 2, and such a structure is also acceptable when the reliability of the valve 6 is high.

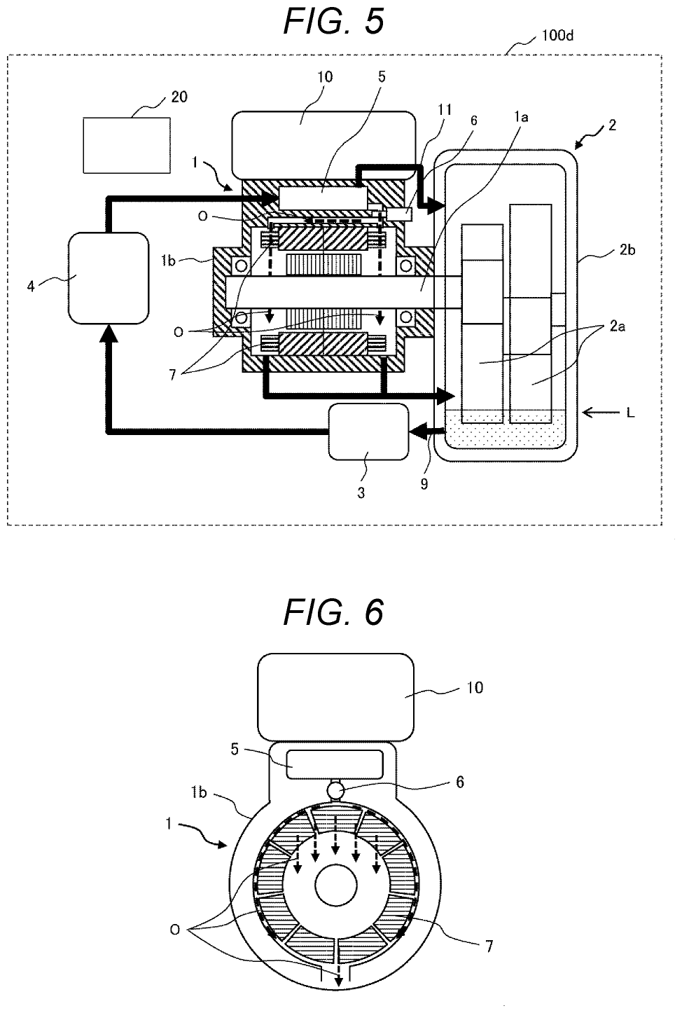

FIG. 6 is a radial cross-sectional view illustrating a fifth example of the vehicle drive system of the present invention. In the configuration of the vehicle drive system illustrated in FIG. 6, by sandwiching the oil reservoir 5 between the motor 1 and the inverter 10 that generate heat, the temperature of the oil can be increased early and the viscosity can be reduced. Note that any of the configurations illustrated in FIGS. 1, 2, 4, and 5 can be applied to the configurations of the electric motor 1 and the speed reducer 2.

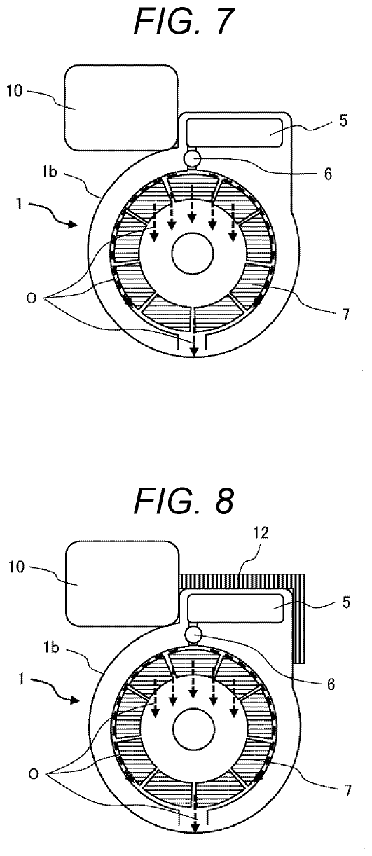

FIG. 7 is a radial cross-sectional view illustrating a sixth example of the vehicle drive system of the present invention. In the configuration of the vehicle drive system illustrated in FIG. 7, the height of the vehicle drive device can be reduced by disposing the inverter 10 on the side of the oil reservoir 5 instead of the upper portion of the oil reservoir 5, and a structure suitable for installation behind the vehicle having a large influence on the floor surface height is obtained. Note that any of the configurations illustrated in FIGS. 1, 2, 4, and 5 can be applied to the configurations of the electric motor 1 and the speed reducer 2.

FIG. 8 is a radial cross-sectional view illustrating a seventh example of the vehicle drive system of the present invention. In the configuration of the vehicle drive system illustrated in FIG. 8, by installing a heat insulating material 12 covering the oil reservoir 5, the upper surface of the oil reservoir 5 can be prevented from coming into contact with air, and the oil can be more easily warmed. This structure can maintain the temperature of the oil even when the vehicle is parked (stopped) for a short time, and can suppress an increase in the stirring loss of the speed reducer 2 under a low temperature environment. Note that any of the configurations illustrated in FIGS. 1, 2, 4, and 5 can be applied to the configurations of the electric motor 1 and the speed reducer 2.

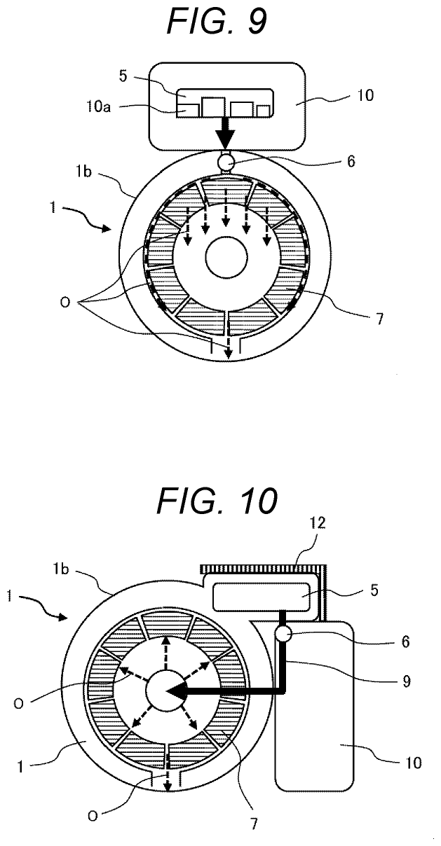

FIG. 9 is a radial cross-sectional view illustrating an eighth example of the vehicle drive system of the present invention. In the case of cooling a heat generator 10a of the inverter 10 with circulating oil, if the oil reservoir 5 is installed in the inverter 10, a smaller shape is obtained by space saving, and there is no need to separately install the oil reservoir 5, so that an effect of cost reduction can be expected. Note that any of the configurations illustrated in FIGS. 1, 2, 4, and 5 can be applied to the configurations of the electric motor 1 and the speed reducer 2.

FIG. 10 is a radial cross-sectional view illustrating a ninth example of the vehicle drive system of the present invention. In order to further reduce the height of the vehicle drive device, it is preferable to lower the position of the oil reservoir 5 and to dispose the inverter 10 on the side of the motor 1. When the oil reservoir 5 is lowered, it is difficult to make the oil flow from the upper portion of the motor 1 to the stator coil 7, so that the oil is blown from the motor rotary shaft 1a. Note that any of the configurations illustrated in FIGS. 1, 2, 4, and 5 can be applied to the configurations of the electric motor 1 and the speed reducer 2.

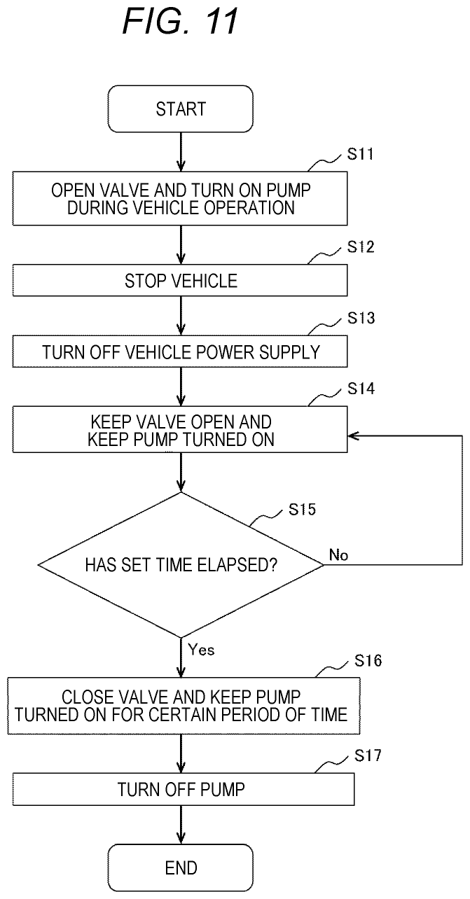

FIG. 11 is a flowchart illustrating a second example of the operation of the vehicle drive system of the present invention. The operations in S11 to S13 in FIG. 11 are similar to those in S1 to S3 in FIG. 3. Immediately after the vehicle stops, the temperature of the electric motor 1 or the inverter 10 may be higher than a specified value that can sufficiently ensure the safety of the vehicle. In this case, it is desirable to circulate the oil until the temperature falls below the specified value. After the vehicle power supply is stopped, it is determined whether a preset time has elapsed (S15), the temperature of the device is lowered by operating the pump 3 in a state where the valve 6 is conducted until the preset time elapses, and then the valve 6 is shut off, and the pump 3 is operated for a certain period of time (S16) to store the oil in the oil reservoir 5. Thereafter, the pump is turned off (S17).

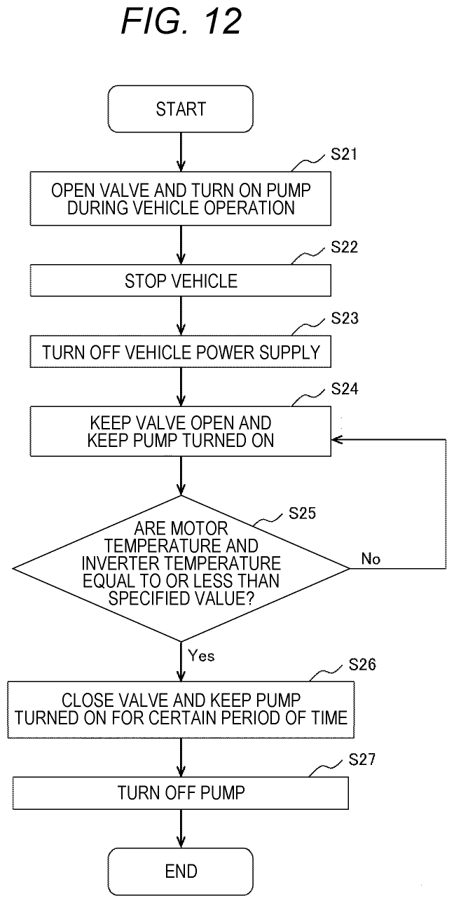

FIG. 12 is a flowchart illustrating a third example of the operation of the vehicle drive system of the present invention. In the flow illustrated in FIG. 11, the oil is circulated until the time set so that the temperature of the electric motor 1 or the inverter 10 sufficiently decreases elapses. However, when the temperature of the motor 1 or the inverter 10 is monitored, it is determined whether the temperature of these devices has decreased to a specified value (S25), and the pump 3 is operated in a state where the valve 6 is conducted until the temperature decreases to the specified value to circulate the oil. As a result, it is possible to reliably lower the temperature of the device and to prevent deterioration in reliability. Thereafter, the valve 6 is shut off, and the pump 3 is operated for a certain period of time (S26) to store the oil in the oil reservoir 5. Thereafter, the pump is turned off (S27).

As described above, according to the present invention, it has been shown that it is possible to provide a vehicle drive system capable of reducing the stirring loss of the oil of the speed reducer at the time of starting the vehicle, sufficiently flowing the cooling oil to the motor, and improving the reliability of the motor.

The present invention is not limited to the embodiments described above, but includes various modifications. For example, the above embodiments have been described in detail for easy understanding of the present invention, and the invention is not necessarily limited to having all the configurations described. A part of the configuration of a certain embodiment can be replaced with the configuration of another embodiment, and the configuration of another embodiment can be added to the configuration of a certain embodiment. It is possible to add, delete, and replace other configurations for a part of the configuration of each embodiment.

### Reference Signs List

1 motor
1a motor rotary shaft
1b electric motor casing
2 speed reducer
2a gear
2b speed reducer casing
3 pump
4 oil cooler
5 oil reservoir
6 valve
7 stator coil
8 oil
9 oil pipe (flow of oil)
10 inverter
10a heat generator
11 breather (pipe for air bleeding)
12 heat insulating material
20 control device
100a, 100b, 100c, 100d vehicle drive system

1. A vehicle drive system comprising:
an electric motor configured to be rotationally driven;
a speed reducer configured to reduce a rotational speed of the electric motor;
a speed reducer casing configured to house the speed reducer;
an oil accommodated in the speed reducer casing;
an oil reservoir provided vertically above the electric motor;
a pump configured to send the oil stored in a lower portion of the speed reducer to the oil reservoir;
a pipe configured to connect the oil reservoir and the electric motor;
a valve provided in the pipe to control conduction/interruption of the pipe; and
a control device configured to control the electric motor, the speed reducer, the pump, and the valve,
wherein the control device controls start and stop of supply of oil from the oil reservoir to the electric motor by the valve.

2. The vehicle drive system according to claim 1, wherein the control device closes the valve after a vehicle stops, drives the pump to send the oil in the speed reducer casing to the oil reservoir until a predetermined time elapses, and stops the pump after the predetermined time elapses to lower an oil level of the speed reducer casing while the vehicle stops.

3. The vehicle drive system according to claim 1, wherein an inverter that controls driving of the electric motor is provided near the oil reservoir.

4. The vehicle drive system according to claim 1, comprising a breather on an upper surface of the oil reservoir, the breather being connected to a portion of the electric motor or the speed reducer where atmospheric air is released.

5. The vehicle drive system according to claim 1, wherein the oil reservoir is provided in an electric motor casing that houses the electric motor.

6. The vehicle drive system according to claim 3, wherein the oil reservoir is installed in an electric motor casing that houses the electric motor or an inverter casing that houses the inverter.

7. The vehicle drive system according to claim 1, wherein a heat insulating material is disposed in at least a part of a periphery of the oil reservoir.

8. The vehicle drive system according to claim 1, wherein the control device maintains a state where the pump is operated in a state where the valve is opened until a set time elapses after a vehicle stops, first closes the valve after a set time elapses, and then stops the pump.

9. The vehicle drive system according to claim 3, wherein the control device maintains a state where the pump is operated in a state where the valve is opened after the vehicle stops, first closes the valve after temperatures of the electric motor and the inverter become equal to or lower than a specified value, and then stops the pump.

10. The vehicle drive system according to claim 1, wherein the control device opens the valve and operates the pump when a temperature of the electric motor rises above a preset value after a vehicle is started.
